(19) United States
(12) Patent Application Publication
(10) Pub. No.: US 2026/0158514 A1
(43) Pub. Date: Jun. 11, 2026

(54) APPARATUS, SYSTEM, AND METHOD FOR IN-SITU APPLICATION OF AN ENGINEERING COATING

(71) Applicant: ROLLS-ROYCE plc, London (GB)

(72) Inventors: Andrew D. NORTON, Derby (GB); Samuel MAYNARD, Derby (GB); Michael GUY, Derby (GB)

(73) Assignee: ROLLS-ROYCE plc, London (GB)

(21) Appl. No.: 19/391,001

(22) Filed: Nov. 17, 2025

(30) Foreign Application Priority Data
Dec. 11, 2024 (GB) 2418132.3

(51) Int. Cl. B05B 13/02; B05B 13/04

(52) U.S. Cl. CPC B05B 13/0278; B05B 13/0431

(57) ABSTRACT

An apparatus for in-situ application of an engineering coating to components has a head section for applying the engineering coating and a multi-part body section for controlling the application process. The body section has a first body member, a second body member, and a third body member interconnected with each other. The first body member has a pre-determined pathway that guides movement and is connected to the head section. The second body member is engaged with the first body member and has at least one hollow channel. The third body member houses an actuator, an engagement pin for connecting with the pathway, and at least one coupling member for interacting with the at least one hollow channel. The actuator ensures precise movement of the head section. The apparatus has one or more gas channels to provide necessary gases to the head section.

### CROSS REFERENCE TO RELATED APPLICATIONS

This specification is based upon and claims the benefit of priority from United Kingdom patent application number GB 2418132.3 filed on Dec. 11, 2024, the entire contents of which is incorporated herein by reference.

### BACKGROUND

### 1. Technical Field

This disclosure relates generally to an apparatus, a system, and a method for in-situ application of an engineering coating to one or more components.

### 2. Brief Description of the Related Art

Components of various machines may be typically coated to protect them during use, for example, to minimise wear and generally improve their safe and useful life. Gas turbine engine components, particularly those located in gas paths of such engines, may be required to withstand extreme temperatures (or high thermal loads) and abrasive contacts for prolonged periods of time and hence maintaining their integrity may be critical. Such components may be typically manufactured from specialised materials, for example, titanium alloys, which may be protected by an engineering coating. The engineering coating may help such components to survive higher operating temperatures and environmental stresses, increases component durability, and improves engine reliability. The engineering coating may be typically formed of a ceramic material and may be deposited on an environmental protective bond coat. The engineering coating may be a thermal barrier coating or an environmental barrier coating

Under service conditions, the gas turbine engine components may be susceptible to various modes of damage, including erosion, oxidation and corrosion from exposure to the gaseous products of combustion, foreign object damage, and attack from environmental contaminants. The source of environmental contaminants may be ambient air, which may be drawn in by the gas turbine engine for cooling and combustion. The type of environmental contaminants in ambient air may vary from location to location but may be of a concern to aircraft as their purpose is to move from location to location. These environmental contaminants may be in addition to the corrosive and oxidative contaminants that result from the combustion of fuel.

Some of these contaminants may result in the loss of engineering coating over the life of the components, leaving a thin portion of the engineering coating, or completely removing a portion of the engineering coating and leaving the underlying component exposed to the operational conditions and potentially damaging such component.

Hence, an apparatus, and/or system, and/or method for applying the engineering coating may be useful. However, in the known art for applying the engineering coating, when one or more components are determined to be worn and/or damaged, the machine (e.g., a gas turbine engine) may require disassembly so that the one or more components may be accessed, and the engineering coating may be applied thereto. This conventional method of application of the engineering coating may be a relatively time consuming and costly procedure. Moreover, this may also reduce the throughput and efficiency of the machine as the machine needs to be disassembled for application of the engineering coating to the one or more components.

### SUMMARY

In a first aspect, there is provided an apparatus for in-situ application of an engineering coating to one or more components includes a head section adapted to selectively apply the engineering coating to the one or more components, and a body section coupled to the head section. The body section includes a first body member having a pre-determined pathway formed on an inner surface thereof. The first body member is drivably coupled with the head section. The body section further includes a second body member at least partially engaged with the first body member. The second body member includes at least one hollow channel. The body section further includes a third body member at least partially engaged with the first body member and the second body member. The third body member includes an engagement pin coupled to an outer surface of the third body member. The engagement pin is adapted to engage with the pre-determined pathway. The third body member further includes at least one coupling member adapted to be received within the at least one hollow channel, and an actuator at least partially housed within the third body member. The actuator is configured to actuate motion of the second body member such that the at least one hollow channel receives the at least one coupling member, and further actuate motion of the first body member such that the pre-determined pathway engages with the engagement pin thereby causing subsequent movement of the head section corresponding to a shape of the pre-determined pathway. The apparatus further includes one or more gas channels provided along the body section to the head section.

The apparatus of the present disclosure may allow repairing of patches on the one or more components of a machine (e.g., a gas turbine engine). The one or more components may be hot-end components such as turbine blades and combustor tiles of the gas turbine engine. In applications where the one or more components are parts of the gas turbine engine, the apparatus of the present disclosure may allow repairing of patches on the one or more components while the gas turbine engine is on-wing to minimise disruption of operation. In other words, for application of the engineering coating to the one or more components, there may be no need for disassembly of the gas turbine engine, thereby preventing any loss of operational efficiency of the gas turbine engine. Moreover, the repairing of patches on the one or more components may be done in a time efficient and cost-efficient manner.

The apparatus of the present disclosure may be brought in proximity to the gas turbine engine, or the apparatus may be at least partially inserted within the gas turbine engine for accessing and repairing of the one or more components by applying the engineering coating thereto.

Further, the apparatus of the present disclosure, in particular the inner surface of the first body member has the pre-determined pathway, which may allow for linear or curved movement of the head section. In other words, the movement of the head section may be dependent on the shape of the pre-determined pathway. As an example, the head section may have the linear movement. As another example, the head section may have a rotational movement. As another example, the head section may have a combination of linear and rotational movement. Further, the first body member may be replaceable as per the application requirement. As an example, when the head section is required to traverse an oval-shaped path, the first body member having the inner surface with the oval shaped pathway may be chosen.

Further, the apparatus while applying the engineering coating to the one or more components may not impart any residual stress or microstructural changes in the one or more components. Further, the one or more components may be prevented from overheating while the engineering coating is applied thereto. Further, the apparatus may be able to apply the engineering coating of desirable dimensions and shapes depending on the target area on the one or more components. Furthermore, a rectangular patch, a circular patch, an oval-shaped patch, or any other arbitrarily shaped patch may be expected to be formed to help contain any in-service coating loss. Furthermore, it may be ensured that no regions may be missed on the one or more components, which may otherwise create a poor coating patch.

The term “engineering coating” according to the present disclosure may be defined as a coating that may alter the surface properties of the substrate or component to which the engineering coating may be applied. The engineering coating may be a thermal barrier coating (or TBC) i.e. a thermally insulating material that is applied to the substrate that is typically exposed to elevated temperatures, or an environmental barrier coating (or EBC) i.e. a barrier coating that is applied to the substrate that is typically exposed to environmental stresses such as icing and erosion.

In some embodiments, the actuator is an electric motor. The electric motor may be easily controlled to adjust speed and torque according to the needs of the application. The electric motor may be a DC motor, AC motor, step motor, or a servo motor. Preferably, the electric motor may be the DC Motor with a 64:1 gearhead to control movement.

In some embodiments, the pre-determined pathway is formed by machining the inner surface of the first body member. The machining process may be milling, turning, grinding, or any other known suitable machining process. The machining process may offer high precision, customization, and flexibility, along with material efficiency and the ability to produce complex geometries, such as, the pre-determined pathways on the inner surface of the first body member.

In some embodiments, the head section includes a spray head for applying the engineering coating to the one or more components. The spray head may be easily adjusted or configured to coat a wide variety of shapes and sizes of components.

In some embodiments, the pre-determined pathway has a linear portion that corresponds to a linear movement of the head section. The linear portion of the pathway may allow translatory or forward and backward movement of the head section upon actuation by the actuator.

In some embodiments, the pre-determined pathway has a curved portion that corresponds to a rotational movement of the head section. The curved portion of the pathway may allow rotary movement of the head section upon actuation by the actuator. The rotary movement of the head section in conjunction with the linear movement of the head section may lead to uniform coating of the one or more components.

In some embodiments, the one or more gas channels includes a first channel for a ceramic powder carried in an inert gas, a second channel for a fluid or gaseous fuel source, and a third channel for a cooling gas. The apparatus of the present disclosure may have one or more gas channels to receive and carry the gases required for forming the engineering coating towards the head section.

In some embodiments, each of the one or more components is a gas turbine engine component. The gas turbine engine components may be hot-end components such as turbine blades and combustor tiles of the gas turbine engine. However, the one or more components may be any other component of the gas turbine engine or any other machine.

In a second aspect, there is provided a system for in-situ application of an engineering coating to one or more components. The system includes an apparatus that further includes a head section adapted to selectively apply the engineering coating to the one or more components. The apparatus further includes a body section coupled to the head section. The body section includes a first body member having a pre-determined pathway formed on an inner surface. The first body member is drivably coupled with the head section. The body section further includes a second body member at least partially engaged with the first body member. The second body member includes at least one hollow channel. The body section further includes a third body member at least partially engaged with the first body member and the second body member. The third body member includes an engagement pin coupled to an outer surface of the third body member. The engagement pin is adapted to engage with the pre-determined pathway. The third body member further includes at least one coupling member adapted to be received within the at least one hollow channel, and an actuator at least partially housed within the third body member. The actuator is configured to actuate motion of the second body member such that the at least one hollow channel receives the at least one coupling member, and further actuate motion of the first body member such that the pre-determined pathway engages with the engagement pin causing subsequent movement of the head section corresponding to a shape of the pre-determined pathway. The apparatus further includes one or more gas channels provided along the body section to the head section. The system further includes a deployment device for deploying the apparatus near the one or more components, and a source of engineering coating material coupled to the deployment device for supplying the engineering coating material to the apparatus.

The system of the present disclosure may allow repairing of patches on the one or more components of a machine (e.g., a gas turbine engine) by using the deployment device. The one or more components may be hot-end components such as turbine blades and combustor tiles. In applications where the one or more components are parts of the gas turbine engine, the system of the present disclosure may allow repairing of patches on the one or more components while the gas turbine engine is on-wing to minimise disruption of operation. In other words, for application of the engineering coating to the one or more components, there may be no need for disassembly of the gas turbine engine, thereby preventing any loss of operational efficiency of the gas turbine engine. Moreover, the repairing of patches on the one or more components by the system of the present disclosure may be done in a time efficient and cost-efficient manner

The system of the present disclosure by using the deployment device may deploy the apparatus in proximity to the gas turbine engine, or the apparatus may be at least partially inserted within the gas turbine engine for accessing and repairing of the one or more components by applying the engineering coating thereto.

Moreover, the system of the present disclosure, in particular the inner surface of the first body member of the apparatus has the pre-determined pathway, which may allow for linear or curved movement of the head section. In other words, the movement of the head section may be dependent on the shape of the pre-determined pathway. As an example, the head section may have the linear movement. As another example, the head section may have a rotational movement. As another example, the head section may have a combination of linear and rotational movement. Further, the first body member may be replaceable as per the application requirement. As an example, when the head section is required to traverse an oval-shaped path, the first body member having the inner surface with the oval shaped pathway may be chosen.

Further, the system of the present disclosure while applying the engineering coating to the one or more components may not impart any residual stress or microstructural changes in the one or more components. Further, the one or more components may be prevented from overheating while the engineering coating is applied thereto. Further, the system may be able to apply the engineering coating of desirable dimensions and shapes depending on the target area on the one or more components. Furthermore, a rectangular patch, a circular patch, an oval-shaped patch, or any other arbitrarily shaped patch may be expected to be formed to help contain any in-service coating loss. Furthermore, it may be ensured that no regions may be missed on the one or more components, which may otherwise create a poor coating patch. Furthermore, the head section of the system may be directed away from the one or more components during initial ignition and set-up to avoid creating a poorly adhered coating patch.

In some embodiments, the shape of the pre-determined pathway is selected from a pathway shape library corresponding to various parts of the one or more components. The pathway shape library may provide a diverse set of pre-designed options, which may be matched to the specific needs of the one or more components to be coated without the need to start from scratch each time.

In some embodiments, the pre-determined pathway is machined on the inner surface of the first body member. The machining process may offer high precision, customization, and flexibility, along with material efficiency and the ability to produce complex geometries, such as, the pre-determined pathways on the inner surface of the first body member.

In some embodiments, the deployment device is a snake robot. The snake robot may navigate through tight, confined spaces where traditional robots or machines may struggle. This makes them ideal for environments with complex geometries or narrow passages, such as inside of the gas turbine engine.

In some embodiments, the pre-determined pathway has a linear portion that corresponds to a linear movement of the head section. The linear portion of the pathway may allow translatory or forward and backward movement of the head section upon actuation by the actuator.

In some embodiments, the pre-determined pathway has a curved portion that corresponds to a rotational movement of the head section. The curved portion of the pathway may allow rotary movement of the head section upon actuation by the actuator. The rotary movement of the head section in conjunction with the linear movement of the head section may lead to uniform coating of the one or more components.

In some embodiments, the engineering coating material is a MCrAlY bond coat and/or an yttria stabilized zirconia (YSZ) ceramic topcoat. The combination of the MCrAlY bond coat and the yttria-stabilized zirconia (YSZ) ceramic topcoat may offer several advantages, particularly in high-performance environments like gas turbines, jet engines, and other high-temperature applications. The MCrAlY layer may provide excellent protection against oxidation and corrosion by forming a stable, adherent oxide layer (such as alumina) on the surface of the one or more components on which the engineering coating may be applied. Further, this may prevent aggressive high-temperature oxidation that may otherwise degrade the engineering coating material over time. The MCrAlY layer may also enhance resistance to erosion from high-velocity gas flow and wear. Further, the yttria-stabilized zirconia's low thermal conductivity may significantly reduce the amount of heat that may reach the one or more components on which the engineering coating may be applied. This may improve its lifespan and performance of the one or more components on which the engineering coating may be applied.

In some embodiments, each of the one or more components is a gas turbine engine component. The gas turbine engine components may be hot-end components such as turbine blades and combustor tiles of the gas turbine engine. However, the one or more components may be any other component of the gas turbine engine or any other machine.

In a third aspect, there is provided a method for in-situ application of an engineering coating to one or more components by using the apparatus. The method includes providing a deployment device, and further providing a source of engineering coating material coupled to the deployment device. The method further includes deploying the apparatus near the one or more components by the deployment device. The method further includes supplying the engineering coating material by the source of engineering coating material to the apparatus. The method further includes actuating the motion of the second body member by the actuator such that the at least one hollow channel receives the at least one coupling member. The method further includes actuating the motion of the first body member by the actuator such that the pre-determined pathway engages with the engagement pin causing subsequent movement of the head section corresponding to a shape of the pre-determined pathway. The method further includes applying the engineering coating material to the one or more components to form the engineering coating by the head section.

The method of the present disclosure may allow repairing of patches on the one or more components of a machine (e.g., a gas turbine engine) by using the deployment device. In applications where the one or more components are parts of the gas turbine engine, the method of the present disclosure may allow repairing of patches on the one or more components while the gas turbine engine is on-wing to minimise disruption of operation. In other words, for application of the engineering coating to the one or more components, the method does not require disassembly of the gas turbine engine, thereby preventing any loss of operational efficiency of the gas turbine engine. Moreover, the method of the present disclosure provides a process by which repairing of patches on the one or more components may be done in a time efficient and cost-efficient manner

Further, by the method of the present disclosure, the apparatus may be brought in proximity to the gas turbine engine, or the apparatus may be at least partially inserted within the gas turbine engine for accessing and repairing of the one or more components by applying the engineering coating thereto.

Moreover, the method of the present disclosure may allow for linear or curved movement of the head section due to the pre-determined pathway formed on the inner surface of the first body member of the apparatus. In other words, the movement of the head section may be dependent on the shape of the pre-determined pathway. As an example, the head section may have the linear movement. As another example, the head section may have a rotational movement. As another example, the head section may have a combination of linear and rotational movement. Further, the first body member may be replaceable as per the application requirement. As an example, when the head section is required to traverse an oval-shaped path, the first body member having the inner surface with the oval shaped pathway may be chosen.

Further, by the method of the present disclosure, the apparatus while applying the engineering coating to the one or more components may not impart any residual stress or microstructural changes in the one or more components. Further, the one or more components may be prevented from overheating while the engineering coating is applied thereto. Further, the apparatus may be able to apply the engineering coating of desirable dimensions and shapes depending on the target area on the one or more components. Furthermore, a rectangular patch, a circular patch, an oval-shaped patch, or any other arbitrarily shaped patch may be expected to be formed to help contain any in-service coating loss. Furthermore, it may be ensured that no regions may be missed on the one or more components, which may otherwise create a poor coating patch. Furthermore, the head section of the apparatus may be directed away from the one or more components during initial ignition and set-up to avoid creating a poorly adhered coating patch.

In some embodiments, the method further includes machining the inner surface of the first body member to provide the pre-determined pathway. The machining process may offer high precision, customization, and flexibility, along with material efficiency and the ability to produce complex geometries, such as, the pre-determined pathways on the inner surface of the first body member.

In some embodiments, the method further includes depositing, the engineering coating material on the one or more components by a spray head to apply the engineering coating. The spray head is coupled with the head section. The spray head may be easily adjusted or configured to coat a wide variety of shapes and sizes of components.

### BRIEF DESCRIPTION OF THE DRAWINGS

Embodiments will now be described by way of example only with reference to the accompanying drawings, in which:

FIG. 1 shows a block diagram of a system for in-situ application of an engineering coating to one or more components, in accordance with an embodiment of the present disclosure;

FIG. 2 shows a perspective view of an apparatus for in-situ application of the engineering coating to the one or more components, in accordance with an embodiment of the present disclosure;

FIG. 3 shows an exploded view of the apparatus of FIG. 2;

FIG. 4 shows a perspective view of the apparatus illustrating one or more gas channels;

FIGS. 5A and 5B show a perspective view of the apparatus in an extended position and a retracted position respectively; and

FIG. 6 is a flowchart depicting various steps of the method for in-situ application of an engineering coating to one or more components.

### DETAILED DESCRIPTION

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein.

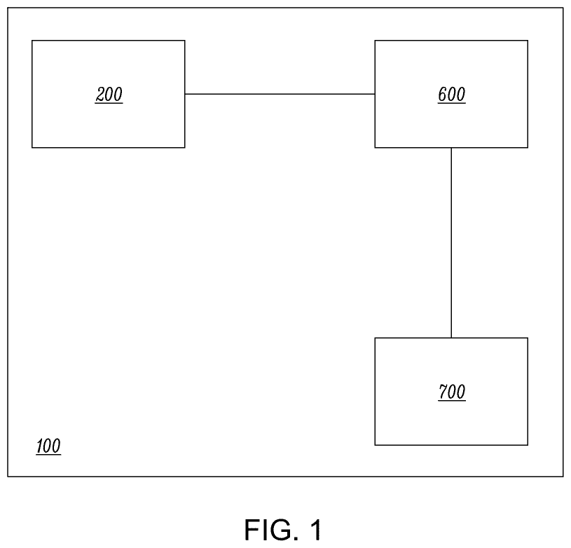

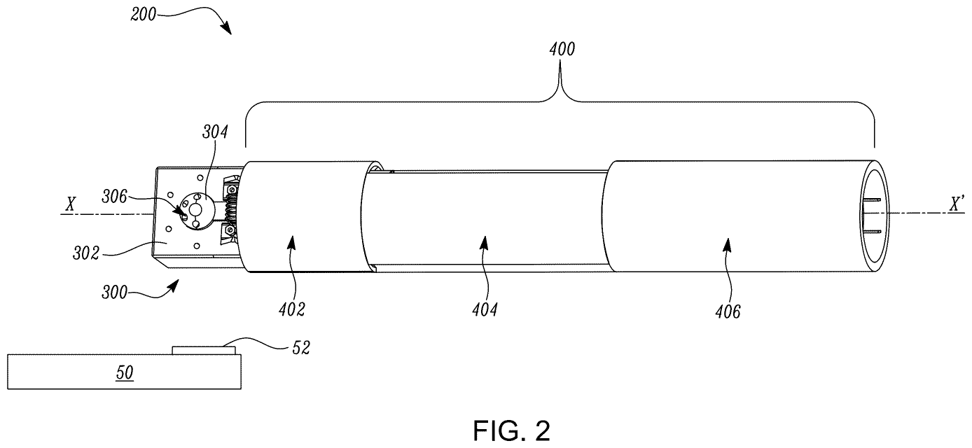

FIG. 1 shows a block diagram of a system 100 for in-situ application of an engineering coating 52 (shown in FIG. 2) to one or more components 50 (shown in FIG. 2), in accordance with an embodiment of the present disclosure. The system 100 includes an apparatus 200 and a deployment device 600 for deploying the apparatus 200 near the one or more components 50 to be coated. FIG. 2 shows a perspective view of the apparatus 200 for in-situ application of the engineering coating 52 to the one or more components 50, in accordance with an embodiment of the present disclosure.

In some embodiments, each of the one or more components 50 is a gas turbine engine component. As an example, the one or more components 50 may be hot-end components of the gas turbine engine, such as, but not limited to, turbine blades and combustor tiles.

Further, the system 100 includes a source 700 of an engineering coating material coupled to the deployment device 600 for supplying the engineering coating material to the apparatus 200. As an example, the source 700 may be removably coupled to the deployment device 600. As another example, the source 700 may be integrally formed with the deployment device 600. Further, the source 700 of engineering coating material may be fluidly coupled to the apparatus 200. As an example, the source 700 of engineering coating material may be fluidly coupled to the apparatus 200 via a silicone flexible tubing. In some embodiments, the engineering coating material is selected from a MCrAlY bond coat and/or an yttria stabilized zirconia (YSZ) ceramic topcoat, depending on the one or more components 50 to be coated for repair, amongst other factors.

The deployment device 600 may be configured to be held at a static position proximal to the gas turbine engine, or within the gas turbine engine, such that the apparatus 200 may be able to access and repair the component 50 of the gas turbine engine by depositing the engineering coating material on areas of delamination of the component 50. Preferably, the deployment device 600 is a snake robot.

The apparatus 200 includes a head section 300 adapted to selectively apply the engineering coating 52 to the one or more components 50. The head section 300 is substantially a cubical or cuboidal shaped section. The head section 300 includes a spray head 302 for applying the engineering coating 52 to the one or more components 50. In other words, the head section 300 is configured to selectively apply the engineering coating 52 to the one or more components 50 via the spray head 302. In other words, the head section 300 includes the spray head 302 which further includes at least one nozzle 304 configured to selectively apply the engineering coating 52 to the one or more components 50 via at least one nozzle hole 306. The at least one nozzle hole 306 may have any shape and size as per application requirements. As an example, the at least one nozzle hole 306 may be more than one nozzle holes 306 of similar or different shapes and sizes. The shapes may be selected from a circular shape, a rectangular shape, an oval shape, or any other shapes which may be envisioned within the scope of the present disclosure. Further, as an example, the head section 300 may include an integrated ignition source as well.

Further, the apparatus 200 includes a body section 400 coupled to the head section 300. The body section 400 is a multi-part body section 400 configured to control the application process, or the coating of the one or more components 50 of the gas turbine engine. The body section 400 includes a first body member 402, a second body member 404, and a third body member 406 interconnected with each other. In other words, the first body member 402 is drivably coupled with the head section 300. The second body member 404 is at least partially engaged with the first body member 402. The third body member 406 is at least partially engaged with the first body member 402 and the second body member 404. As an example, the body section 400 and/or the first body member 402, and/or the second body member 404, and/or the third body member 406 may be made from a metal, such as stainless steel. As another example, the body section 400 and/or the first body member 402, and/or the second body member 404, and/or the third body member 406 may be made from a suitable stiff polymer.

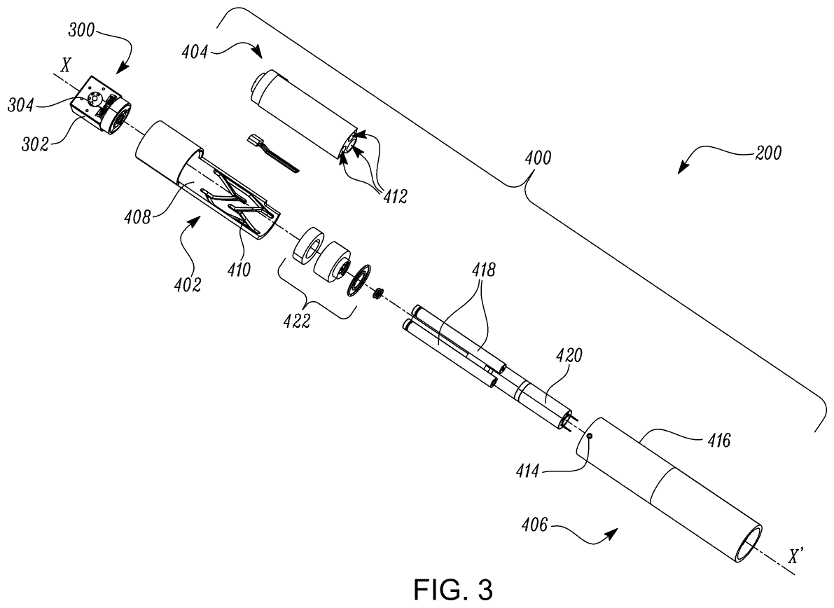

FIG. 3 shows an exploded view of the apparatus 200 for in-situ application of the engineering coating 52 to the one or more components 50, in accordance with an embodiment of the present disclosure. The apparatus 200 includes the head section 300. The head section 300 of the apparatus 200 is the part that directly applies the engineering coating 52 to the one or more components 50. The head section 300 includes the spray head 302 which further includes the at least one nozzle 304 for depositing the engineering coating material on the one or more components 50. Further, the head section 300 is selectively controlled. In other words, the head section 300 is directed to apply engineering coating in a controlled manner, depending on the positioning of the one or more components 50 or the type of engineering coating 52 being applied.

Further, the apparatus 200 includes the body section 400. The body section 400 is configured to connect the head section 300 to the rest of the apparatus 200 along a longitudinal axis X-X′ defined by the apparatus 200. In other words, the apparatus 200 includes the head section 300 and the body section 400 coupled to the head section 300 along the longitudinal axis X-X′. The body section 400 includes elements or components that are configured to provide mechanical movement to the head section 300 in the controlled manner. In other words, the body section 400 includes the first body member 402, the second body member 404, and the third body member 406 interconnected with each other along the longitudinal axis X-X′ and configured to provide mechanical movement to the head section 300 in the controlled manner.

The first body member 402 includes an inner surface 408 with a pre-determined pathway 410. In other words, the body section 400 includes the first body member 402 having the pre-determined pathway 410 formed on the inner surface 408 thereof. As an example, the pre-determined pathway 410 may be a channel, track, or groove designed to guide the movement of other parts of the apparatus 200. The pre-determined pathway 410 may define a specific motion or trajectory, which may ensure precise movement of the head section 300. In some embodiments, the pre-determined pathway 410 is formed by machining the inner surface 408 of the first body member 402. In other words, the pre-determined pathway 410 is machined on the inner surface 408 of the first body member 402. In some embodiments, the pre-determined pathway 410 has a linear portion that corresponds to a linear movement of the head section 300. In some embodiments, the pre-determined pathway 410 has a curved portion that corresponds to a rotational movement of the head section 300. FIG. 3 illustrates the pre-determined pathway 410 having both the linear portion and the curved portion. As an example, the number of portions, whether linear or curved in the pre-determined pathway 410 may be varied to suit the specific use cases, trading off the manufacturing constraints against the need for an even thickness of engineering coating 52 through overlapping spray paths.

Further, in some embodiments, the shape of the pre-determined pathway 410 is selected from a pathway shape library corresponding to various parts of the one or more components 50. As an example, a position in the pre-determined pathway 410 may define a home position, which may allow the head section 300 to point away from the one or more components 50 to which the engineering coating 52 may be applied. In other words, the home position may allow the head section 300 to be pointing away from the one or more components 50 during the initial set-up and flame stabilisation. The home position according to the present disclosure may be defined as a position of the head section 300 with the head section 300 facing away from the one or more components 50 to be coated with the engineering coating 52.

With continuous reference to FIG. 3, the body section 400 includes the second body member 404 such that the second body member 404 is configured to be at least partially engaged with the first body member 402. The second body member 404 includes at least one hollow channel 412. Further, the body section 400 includes the third body member 406, which is configured to be at least partially engaged with the first body member 402 and the second body member 404. The third body member 406 includes an engagement pin 414 coupled to an outer surface 416 of the third body member 406. The engagement pin 414 is adapted to engage with the pre-determined pathway 410. The engagement pin 414 rides along the pre-determined pathway 410, enabling precise control over the movement of the head section 300.

Further, the third body member 406 includes at least one coupling member 418 adapted to be received within the at least one hollow channel 412. Further, the third body member 406 includes an actuator 420 at least partially housed within the third body member 406. The actuator 420 is configured to actuate motion of the second body member 404 such that the at least one hollow channel 412 receives the at least one coupling member 418, and further actuate motion of the first body member 402 such that the pre-determined pathway 410 engages with the engagement pin 414 thereby causing subsequent movement of the head section 300 corresponding to a shape of the pre-determined pathway 410.

In some embodiments, the actuator 420 is an electric motor. The actuator 420 is disposed distal from the head section 300, as shown in FIG. 3, along the body section 400. As an example, the actuator 420 may be disposed proximal to the head section 300. Further, the actuator movement may be coordinated with the position of the engagement pin 414 on the pre-determined pathway 410. As an example, if the actuator 420 may be driving forward such that the engagement pin 414 may reach the top of the pre-determined pathway 410, the actuator 420 may then need to reverse the movement such that the engagement pin 414 may follow the pre-determined pathway 410. If the timing is not correct, the actuator 420 may change direction too soon or too late. The use of encoders and sensors may further be required to ensure that the pre-determined pathway 410 is followed correctly.

Further, the body section 400 includes a slip ring 422. The slip ring 422 is configured to be disposed between the rear of the head section 300 and the front of the second body member 404, when the apparatus 200 is assembled along the longitudinal axis X-X′.

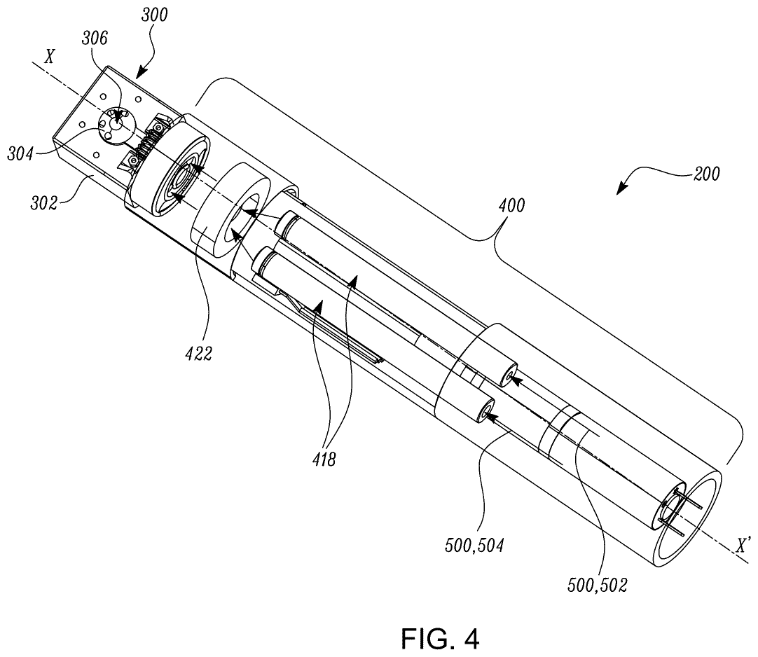

FIG. 4 shows a perspective view of the apparatus 200 of FIGS. 2 and 3, illustrating one or more gas channels 500, in accordance with an embodiment of the present disclosure. The apparatus 200 includes the one or more gas channels 500 provided along the body section 400 to the head section 300. The one or more gas channels 500 includes a first channel 502 for a ceramic powder carried in an inert gas, a second channel 504 for a fluid or gaseous fuel source, and a third channel (not shown) for a cooling gas. As an example, the fuel may be an oxy gas. The ceramic powder carried in an inert gas and the fluid or gaseous fuel source flow separately through two hollow channels 412 respectively and then go through the rotational slip ring 422 that allows the gas to be held internally. Afterwards, the ceramic powder carried in an inert gas and the fluid or gaseous fuel source flow towards the head section 300.

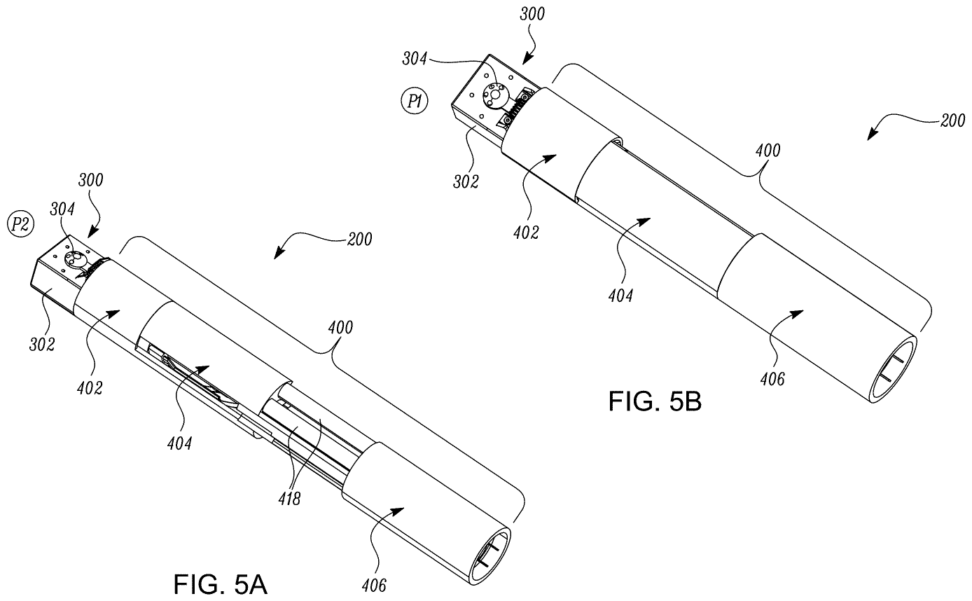

FIGS. 5A and 5B show a perspective view of the apparatus 200 of FIGS. 2, 3 and 4 in an extended position “P2” and a retracted position “P1” respectively, in accordance with an embodiment of the present disclosure. The apparatus 200 includes a combination of the actuator 420, the pre-determined pathway 410, and the engagement pin 414 such that upon actuation of the actuator 420, the head section 300 exhibits a linear as well as rotational movement. The head section 300 moves from the retracted position “P1” towards the extended position “P2” when the actuator 420 moves in a first direction and further from the extended position “P2” towards the retracted position “P1”, when the actuator 420 moves in a second direction, with the second direction of the actuator 420 being opposite to the first direction of the actuator 420. As an example, the linear distance covered by the head section 300 from the retracted position “P1” to the extended position “P2” may be 20 mm. However, the linear distance may depend upon the pre-determined pathway 410.

Thus, the apparatus of the present disclosure may allow repairing of patches on the one or more components. The apparatus, in particular the inner surface of the first body member has the pre-determined pathway, which may allow for linear or curved movement of the head section. In other words, the movement of the head section may be dependent on the shape of the pre-determined pathway. As such, the first body member may be replaceable to get the pre-determined pathway with new shape in order to manipulate the movement of the head section.

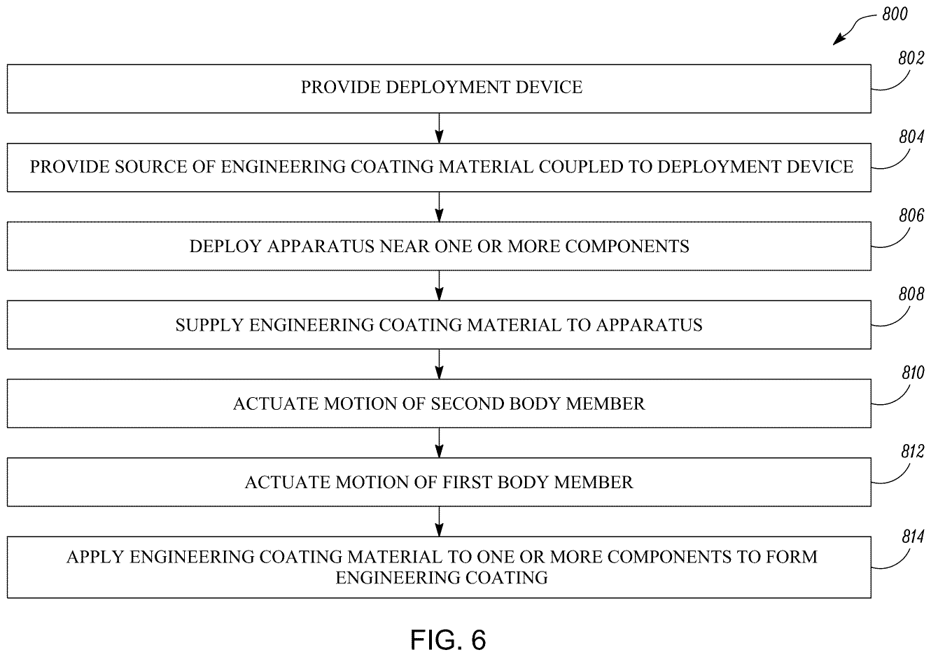

FIG. 6 is a flowchart depicting various steps of a method 800 for in-situ application of the engineering coating 52 (shown in FIG. 2) to the one or more components 50 (shown in FIG. 2) using the apparatus 200. At step 802, the method 800 includes providing the deployment device 600. At step 804, the method 800 includes providing the source 700 of engineering coating material coupled to the deployment device 600. At step 806, the method 800 includes deploying the apparatus 200 near the one or more components 50 by the deployment device 600. At step 808, the method 800 includes supplying, by the source 700 of engineering coating material, the engineering coating material to the apparatus 200. At step 810, the method 800 includes actuating, by the actuator 420, motion of the second body member 404 such that the at least one hollow channel 412 receives the at least one coupling member 418. In some embodiments, the method 800 further includes machining the inner surface 408 of the first body member 402 to provide the pre-determined pathway 410. At step 812, the method 800 includes actuating, by the actuator 420, motion of the first body member 402 such that the pre-determined pathway 410 engages with the engagement pin 414 causing subsequent movement of the head section 300 corresponding to a shape of the pre-determined pathway 410. At step 814, the method 800 further includes applying, by the head section 300, the engineering coating material to the one or more components 50 to form the engineering coating 52. In some embodiments, the method 800 further includes depositing, by the spray head 302, the engineering coating material on the one or more components 50 to apply the engineering coating 52. The spray head 302 is coupled with the head section 300.

The apparatus, system, and method of the present disclosure may improve an in-situ application of an engineering coating to one or more components. Specifically, the apparatus, system, and method may facilitate in-situ application of the engineering coating to one or more components using movement of the head section as governed by the pre-determined pathway.

Various examples have been described, each of which comprise various combinations of features. It will be appreciated by those skilled in the art that, except where clearly mutually exclusive, any of the features may be employed separately or in combination with any other features and the invention extends to and includes all combinations and sub-combinations of one or more features described herein.

We claim

1. An apparatus for in-situ application of an engineering coating to one or more components, the apparatus comprising:
a head section adapted to selectively apply the engineering coating to the one or more components;
a body section coupled to the head section, the body section comprising:
a first body member having a pre-determined pathway formed on an inner surface thereof, wherein the first body member is drivably coupled with the head section;
a second body member at least partially engaged with the first body member, wherein the second body member includes at least one hollow channel; and
a third body member at least partially engaged with the first body member and the second body member, the third body member comprising:
an engagement pin coupled to an outer surface of the third body member, wherein the engagement pin is adapted to engage with the pre-determined pathway;
at least one coupling member adapted to be received within the at least one hollow channel; and
an actuator at least partially housed within the third body member, wherein the actuator is configured to actuate:
motion of the second body member such that the at least one hollow channel receives the at least one coupling member; and
motion of the first body member such that the pre-determined pathway engages with the engagement pin thereby causing subsequent movement of the head section corresponding to a shape of the pre-determined pathway; and
one or more gas channels provided along the body section to the head section.

2. The apparatus of claim 1, wherein the actuator is an electric motor.

3. The apparatus of claim 1, wherein the pre-determined pathway is formed by machining the inner surface of the first body member.

4. The apparatus of claim 1, wherein the head section comprises a spray head for applying the engineering coating to the one or more components.

5. The apparatus of claim 1, wherein the pre-determined pathway has a linear portion that corresponds to a linear movement of the head section.

6. The apparatus of claim 1, wherein the pre-determined pathway has a curved portion that corresponds to a rotational movement of the head section.

7. The apparatus of claim 1, wherein the one or more gas channels comprises a first channel for a ceramic powder carried in an inert gas, a second channel for a fluid or gaseous fuel source, and a third channel for a cooling gas.

8. The apparatus of claim 1, wherein each of the one or more components is a gas turbine engine component.

9. A system for in-situ application of an engineering coating to one or more components, the system comprising:
an apparatus comprising:
a head section adapted to selectively apply the engineering coating to the one or more components;
a body section coupled to the head section, the body section comprising:
a first body member having a pre-determined pathway formed on an inner surface, wherein the first body member is drivably coupled with the head section;
a second body member at least partially engaged with the first body member, wherein the second body member includes at least one hollow channel;
a third body member at least partially engaged with the first body member and the second body member, the third body member comprising:
an engagement pin coupled to an outer surface of the third body member, wherein the engagement pin is adapted to engage with the pre-determined pathway;
at least one coupling member adapted to be received within the at least one hollow channel; and
an actuator at least partially housed within the third body member, wherein the actuator is configured to actuate:
motion of the second body member such that the at least one hollow channel receives the at least one coupling member; and
motion of the first body member such that the pre-determined pathway engages with the engagement pin causing subsequent movement of the head section corresponding to a shape of the pre-determined pathway; and
one or more gas channels provided along the body section to the head section;
a deployment device for deploying the apparatus near the one or more components; and
a source of engineering coating material coupled to the deployment device for supplying the engineering coating material to the apparatus.

10. The system of claim 9, wherein the shape of the pre-determined pathway is selected from a pathway shape library corresponding to various parts of the one or more components.

11. The system of claim 9, wherein the pre-determined pathway is machined on the inner surface of the first body member.

12. The system of claim 9, wherein the deployment device is a snake robot.

13. The system of claim 9, wherein the pre-determined pathway has a linear portion that corresponds to a linear movement of the head section.

14. The system of claim 9, wherein the pre-determined pathway has a curved portion that corresponds to a rotational movement of the head section.

15. The system of claim 9, wherein the engineering coating material is a MCrAlY bond coat and/or an yttria stabilized zirconia ceramic topcoat.

16. The system of claim 9, wherein each of the one or more components is a gas turbine engine component.

17. A method for in-situ application of an engineering coating to one or more components by using the apparatus of claim 1, the method comprising the steps of:
providing a deployment device;
providing a source of engineering coating material coupled to the deployment device;
deploying the apparatus near the one or more components by the deployment device;
supplying, by the source of engineering coating material, the engineering coating material to the apparatus;
actuating, by the actuator, motion of the second body member such that the at least one hollow channel receives the at least one coupling member;
actuating, by the actuator, motion of the first body member such that the pre-determined pathway engages with the engagement pin causing subsequent movement of the head section corresponding to a shape of the pre-determined pathway; and
applying, by the head section, the engineering coating material to the one or more components to form the engineering coating.

18. The method of claim 17, further comprising machining the inner surface of the first body member to provide the pre-determined pathway.

19. The method of claim 17, further comprising:
depositing, by a spray head, the engineering coating material on the one or more components to apply the engineering coating, wherein the spray head is coupled with the head section.
